(19) United States
(12) Patent Application Publication
(10) Pub. No.: US 2016/0242561 A1
(43) Pub. Date: Aug. 25, 2016

(54) AIRBED CONTROL SYSTEM FOR SIMULTANEOUS ARTICULATION AND PRESSURE ADJUSTMENT

(71) Applicant: RAPID AIR LLC, Pewaukee, WI (US)

(72) Inventors: John Joseph Riley, Brookfield, WI (US); David Delory Driscoll, JR., Milwaukee, WI (US); Susan Marie Hrobar, Brookfield, WI (US)

(21) Appl. No.: 15/053,769

(22) Filed: Feb. 25, 2016

Related U.S. Application Data
(60) Provisional application No. 62/120,720, filed on Feb. 25, 2015.

(51) Int. Cl. A47C 27/08; G05B 15/02; F04D 27/00; A47C 20/04; A47C 27/10

(52) U.S. Cl. CPC A47C 27/082; A47C 20/04; A47C 27/10; A47C 27/083; F04D 27/00; G05B 15/02

(57) ABSTRACT

An airbed system includes: an air mattress comprising one or more air chambers; an adjustable base comprising one or more articulation points; and a pump connected to the one or more air chambers of the air mattress; and a control system, wherein the control system is configured to: control the adjustable base to perform an articulation operation; and while the articulation operation is ongoing, control the pump to inflate or deflate the one or more air chambers of the air mattress based on the articulation operation being performed.

### CROSS-REFERENCE TO RELATED APPLICATIONS

This patent application claims the benefit of U.S. Provisional Patent Application No. 62/120,720, filed Feb. 25, 2015, which is incorporated by reference herein in its entirety.

### BACKGROUND

Airbed chamber designs have evolved from simple, single chamber designs made from pvc or rubber to multi-zone systems made from urethane film. In today's market, commercially available consumer airbeds may offer up to 6 separately controlled zones within a mattress. Air pump technology has evolved from simple squirrel cage blower systems to today's dual diaphragm pumps. The related airbed control systems have evolved from simple wired hand remotes with up/down buttons to wireless hand controls operated on smart devices. Early hand controls did not feature a display. Today's controls feature digital displays that use alpha numeric symbols as well as custom graphics. System accuracy has also greatly improved with some systems capable of controlling air pressure within an accuracy range of +/−0.01 psi.

Similarly, the bases for airbeds have evolved. Early airbed designs used traditional box springs as a base. These designs evolved into platform beds, for which a box spring wasn't necessary. Today the market offers a number of adjustable bases that replace the earlier platform and the box spring designs. Such bases offer users the ability to adjust their head, knee and leg elevations and some now offer additional flexible joints under the spine, hips and calves. Certain designs incorporate airbeds. Based on the airbed design, some systems place the internal mattress that contains the air chambers directly on the jointed surface of the adjustable base.

Additionally, “smart beds” have begun to emerge which include an array of sensor technologies for qualifying sleep quality via quantification of gross movement, and biometric assessments like heart rate, respiration, body temperature, and noise. These smart beds may further integrate a number of systems for adjustment of the sleep surface, articulation, firmness, and temperature control, either manually by the user or automatically in response to certain conditions (such as triggering an adjustment of the sleep surface in response to a detection of snoring or sleep apnea).

### SUMMARY

In an exemplary embodiment, an airbed system is provided. The airbed system includes: an air mattress comprising one or more air chambers; an adjustable base comprising one or more articulation points; and a pump connected to the one or more air chambers of the air mattress; and a control system, wherein the control system is configured to: control the adjustable base to perform an articulation operation; and while the articulation operation is ongoing, control the pump to inflate or deflate the one or more air chambers of the air mattress based on the articulation operation being performed.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts an exemplary airbed environment in which exemplary embodiments of the invention may be implemented.

FIG. 2 depicts various components of an exemplary airbed environment in which exemplary embodiments of the invention may be implemented.

FIG. 3 is a flowchart illustrating exemplary processes for pressure compensation by an airbed control system based on a direct drive user input corresponding to adjusting the articulation of the airbed.

FIG. 4 is a flowchart illustrating exemplary processes for pressure compensation by an airbed control system based on a target setting for articulation and pressure.

FIGS. 5A and 5B illustrate an exemplary air mattress and an adjustable base in exemplary articulation configurations.

FIGS. 6A-6C are flowcharts illustrating an exemplary process flow for a multi-chamber (or multi-zone) system capable of direct drive control or recall-based control.

FIG. 7 is a three-dimensional plot illustrating pressure response data sets corresponding to different weights under uniform initial pressure conditions in multiple zones of a multi-zone system.

FIG. 8 is a three-dimensional plot illustrating pressure response data sets corresponding to a certain weight with uniform and non-uniform initial pressure conditions in multiple zones of a multi-zone system.

FIG. 9 is a three-dimensional plot illustrating pressure response data sets corresponding to different weights with non-uniform initial pressure conditions in multiple zones of a multi-zone system.

### DETAILED DESCRIPTION

Exemplary embodiments of the present invention provide an airbed control system that allows a user to maintain or achieve a desired firmness or comfort level even after an articulation operation is performed with respect to an adjustable base for the airbed—e.g., by maintaining or targeting a desired pairing for a pressure level for one or more air chambers of the airbed with a particular articulation for the adjustable base. These exemplary embodiments make the airbed simpler for the user to control, and allows the airbed to more efficiently and quickly reach a desired setting. Further, these exemplary embodiments are usable with airbeds with any number of articulated joints and any number of air mattress chambers.

Articulation of an adjustable base generally changes the distribution of mass on the sleep surface of the bed. In fact, that is largely the intent. For airbeds that are attached to an adjustable frame, the change in distribution of mass caused by articulation, as well as the compression of air chambers caused by articulation, is likely to cause a change in air pressure within the air chambers. This may cause the bed to become firmer or softer than what the user prefers, and as a result, the user may desire to initiate a secondary action by adjusting the air pressure to a more desired level.

The combined effect due to the change in articulation and the change in pressure brought on by an articulation operation may thus significantly impact the way a mattress feels to the user. The typical controllable air pressure range in an airbed system is about 0.10 psi to 1.30 psi. When an adjustable base is articulated, it will almost certainly alter chamber pressure. These changes can be as much as −0.15 psi and +0.30 psi, which is a noticeable variance that can meaningfully affect comfort levels. Beyond the comfort aspect of these changes, the possibility of over pressuring the chamber by more than 40% can also become a concern. This is the case in both single chamber designs as well as in mattresses which incorporate multiple chambers into each side of the bed. Such multi-chamber designs are commonly referred to as multi-zone systems.

Sometimes a pressure reaction to articulation can be counterintuitive in these multi-zone systems. For example, articulations which normally result in an increase in chamber pressure will sometimes result in a significant reduction in chamber pressure. It is thus desirable to separate the consumer from these complexities such that the consumer does not need to manually adjust the pressure in response to a desired change in articulation. Instead, embodiments of the invention provide the consumer with an easy-to-use control interface through which the airbed achieves a desired comfort level with a corresponding articulation in a fast and efficient manner.

Beyond the first order effects mentioned above, changing the articulation of a mattress may, for example, affect the top sleep surface and the mattress bottom differently as a result of mattress deformation, especially near the articulation joints. There can be a resultant “crush” on the top sleep surface as elevations increase and an opposite de-compressive effect, again especially on the top sleep surface, resulting from a reduced angle of elevation. The amount of change will be affected by multiple variables including, for example, degree and direction off articulation, mattress design, mattress materials, air chamber design, air chamber positioning versus joint articulation location, and number of air chambers.

The relationship between a given articulation level and air chamber pressure combines to create a particular comfort level. Embodiments of the invention allow a user to efficiently achieve a desired combined setting (e.g., a “pairing”) based on the user's preferences (e.g., predetermined preferences set by the user) or based on default or other configurations of the airbed control system. In an exemplary embodiment, the user can control the airbed by selecting a particular function (such as a “massage” function corresponding to a particular articulation and pressure level) or a particular setting (such as a memory setting containing a previously saved pairing of an articulation and pressure level), or the user can control the airbed through a “direct drive” control input (e.g., holding down a button or multiple buttons to cause the airbed to continue to articulate in a certain way or towards a certain direction while the button is held).

With respect to control operations where the user input directs the airbed to achieve a particular pairing between an articulation configuration and a pressure level in the air mattress chamber(s), the airbed control system determines what effect changing the airbed from the current articulation configuration to the desired articulation configuration will have on the pressure level in the air mattress chamber(s), and uses that information in determining whether to inflate or deflate the air mattress chamber(s). Pressure readings for the air mattress chamber(s) taken while the articulation and pressure adjustments are ongoing may be used to further refine the determination of whether to continue to inflate or deflate.

With respect to control operations where the user input directs the airbed to articulate in a certain direction or in a certain way through a direct drive input, in one exemplary embodiment, the airbed control system may compensate for the effect that the articulation has on the pressure level in the air mattress chamber(s) by making an appropriate adjustment to the air mattress chamber(s) (e.g., through inflation or deflation) to cancel out the effect of the articulation. The compensation is performed in real-time while the direct drive input is being provided based on pressure readings taken while the direct drive input and corresponding articulation operation is ongoing.

In another exemplary embodiment, another way in which direct drive inputs may be processed is to have predefined pressure settings associated with certain articulation configurations (e.g., according to user-input preferences or factory-defined default settings). For example, certain ranges of articulation may have certain preferred pressure levels associated therewith, and once the direct drive input causes the articulation to cross over into a certain range, the target pressure level that the airbed control system aims to achieve for the air mattress chamber is changed to the preferred pressure level associated with that articulation. In another example, some other types of control laws may be followed during the direct drive input to dictate what the target pressure is during the direct drive input (such as maintaining pressure for a particular range of articulations). It will be appreciated that in other exemplary implementations, the relationship between the desired pressure and the articulation during a direct drive input may be defined in another way (e.g., via a proportional or inversely proportional relationship).

The pressure readings used for these control options may be performed according to the techniques described in U.S. patent application Ser. No. 14/571,834, filed on Dec. 16, 2014, which is incorporated by reference herein in its entirety. These pressure measurements (i.e., corresponding to “static” pressure measurements that are able to be obtained dynamically while the articulation and/or inflate/deflate operations are ongoing), in combination with a set of system qualifications and control laws and with calibration of the system, provide the airbed control system with the information it uses for determining whether to inflate or deflate during an articulation operation, so as to achieve a desired amount of pressure compensation taking into account the changes in articulation caused by the articulation operation.

Generally speaking, the articulation (a desired or a real-time value) and current/desired chamber pressure (for all zones) are inputs into a lookup matrix or state equation (whether to use a matrix or equation solution may be based on the physical geometry of the base and air mattress chambers, and in most cases either will work). The output of the lookup matrix or state equation will be the expected change in pressure for all chambers in the system. The expected change in pressure can then be used to initiate pressure adjustments (e.g., via inflating or deflation one or more chambers) simultaneous with the articulation to achieve or maintain the user's desired comfort level.

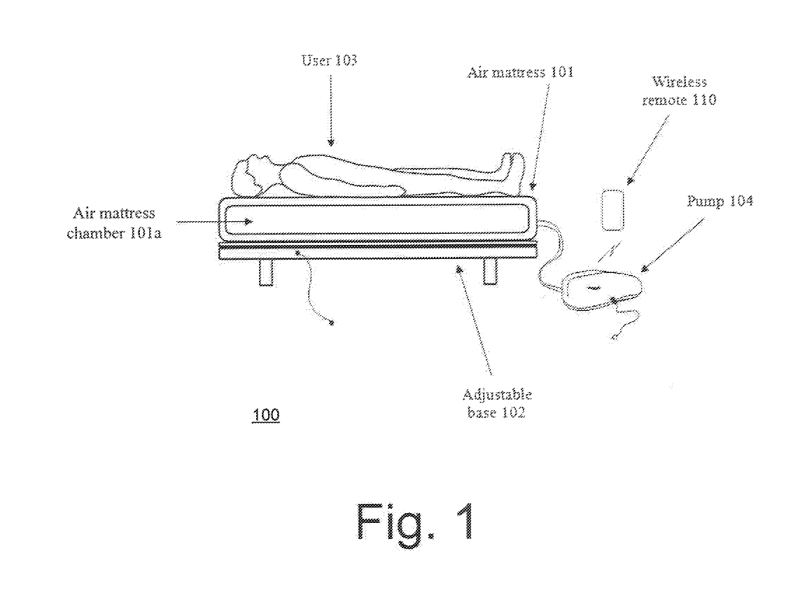

FIG. 1 depicts an exemplary airbed environment 100 in which exemplary embodiments of the invention may be implemented. The exemplary airbed environment 100 includes an air mattress 101 on an adjustable base 102. A user 103 is depicted as lying down the air mattress 101, which includes at least one internal air mattress chamber 101a. The air mattress 101 is connected to a pump 104 via one or more tubes (e.g., corresponding to the number of zones or chambers of the air mattress), and the user 103 may use a wireless remote 110 to control the pump system 104 and/or the adjustable base 102.

The control system(s) for the adjustable base 102 and the pump 104 is/are not depicted, but it will be appreciated that in an exemplary implementation the control system for the pump 104 may be integrated in the pump housing, and that the same control system that is use for the pump 104 may also be used to control the adjustable base 102. In other exemplary implementations, the pump 104 and adjustable base 102 may have separate control systems, which may be controlled via the wireless remote 110. It will also be appreciated that other exemplary environments may utilize a wired remote instead of a wireless remote 110, and may utilize one or more remotes.

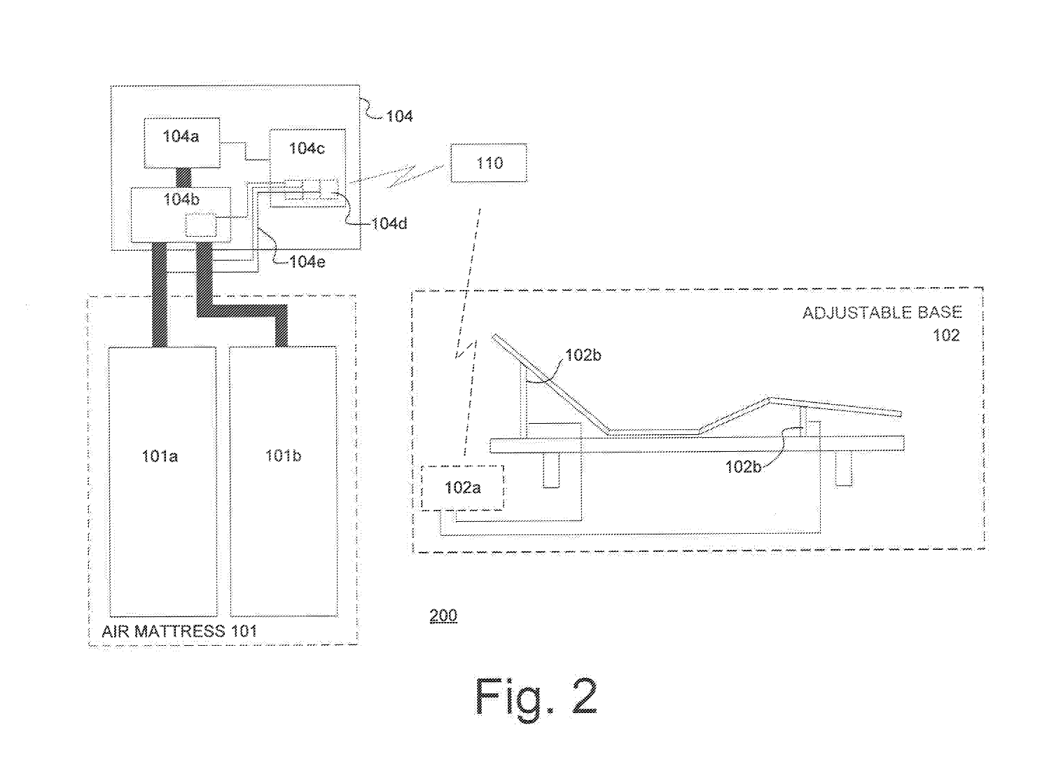

FIG. 2 depicts various components of an exemplary airbed environment 200 in which exemplary embodiments of the invention may be implemented. Similar to FIG. 1, FIG. 2 depicts an air mattress 101, a pump 104, and an adjustable base 102. The air mattress 101 includes two chambers 101a and 101b, each chamber corresponding to a different side of the air mattress. Each of these chambers is connected to a manifold 104b of the pump 104 via a separate tube. It will be appreciated that in other exemplary airbed environments, the air mattress may include a different number of chambers, as well as multiple zones, where each zone or chamber is connected to the manifold 104b through a separate tube (for example, in a 4-zone or 6-zone system, there may be separate air mattress chambers corresponding to a head region, torso region, and foot region for each side of the air mattress). The manifold 104b is connected to a pumping apparatus 104a which pumps air from atmosphere through the manifold 104b into the air mattress 101 (and may also be configured to dump air from the air mattress 101 out to atmosphere). The pumping apparatus 104a is controlled by a control unit 104c of the pump 104.

In the example shown in FIG. 2, the control unit 104c contains one or more pressure transducers 104d connected to the manifold 104b and/or to separate tubes between the manifold 104b and air mattress 101 via pressure tubes 104e. These pressure transducers 104d provide pressure readings corresponding to the chambers of the air mattress 101 to enable the control unit 104c to determine what the current pressure inside the chambers is. In certain implementations, a single pressure transducer 104d may be connected to the manifold 104b via a pressure tube 104e, while in other implementations, pressure transducers 104d may be provided which are connected to respective air flow tubes between the air mattress 101 and the manifold 104b or to the chambers of the air mattress 101a and 101b (in addition to or as an alternative to a pressure transducer 104d corresponding to the manifold 104b). For exemplary environments having more than two air mattress chambers or zones, additional pressure transducers 104d may be provided for each additional chamber or zone.

The control unit 104c is further in wireless or wired communication with user remote 110, which a user may use to provide user input (such as a direct drive input with respect to pressure or articulation or a memory recall input) to the pump 104. FIG. 2 also depicts a separate control unit 102a of the adjustable base 102, which is also in communication with user remote 110. The control unit 102a provides control signals to actuators 102b which cause articulation of the adjustable base 102 (which in turn causes articulation of an air mattress 101 that is disposed on the adjustable base 102). Although FIG. 2 depicts separate control units 102a and 104c for the adjustable base 102 and pump 104, it will be appreciated that other exemplary environments may include an integrated system where a single control unit is configured for controlling both the adjustable base 102 and the pump 104. Additionally, although FIG. 2 depicts a single user remote 110, other exemplary environments may include one or multiple user remotes, each of which may communicate via wired or wireless communication with the control unit(s) of the airbed system.

It will be appreciated that the exemplary environments depicted in FIGS. 1 and 2 are merely exemplary, and that embodiments of the invention are usable with respect to various other environments that utilize articulating components in connection with one or more air-holding chambers.

It will further be appreciated that the control unit(s) of the airbed system include one or more processors in communication with one or more non-transitory computer-readable mediums (e.g., RAM, ROM, PROM, volatile, nonvolatile, or other electronic memory mechanism) with processor-executable instructions stored thereon for carrying out the various operations described herein. It will thus be appreciated that execution of those processor-executable instructions facilitates various user input and control operations described herein.

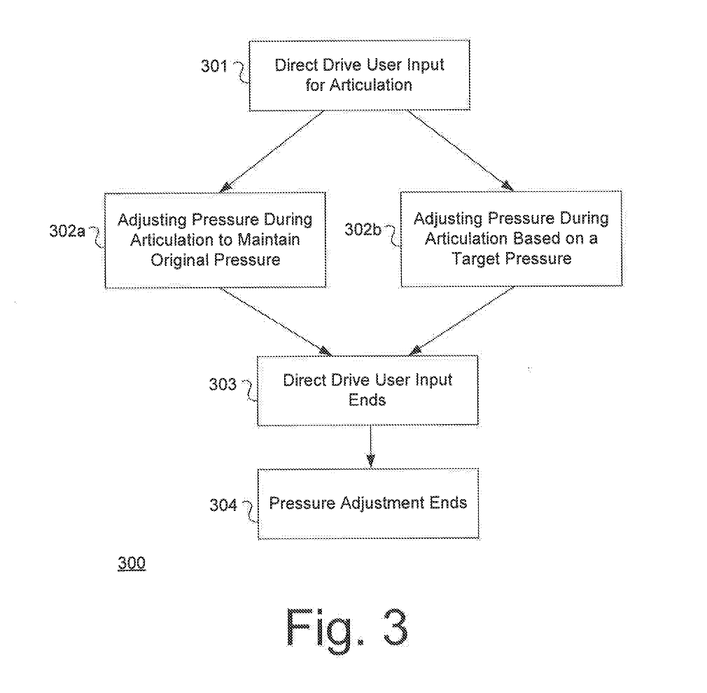

FIG. 3 is a flowchart 300 illustrating exemplary processes for pressure compensation by an airbed control system based on a direct drive user input corresponding to adjusting the articulation of the airbed. The process shown in flowchart 300 begins with a direct drive user input corresponding to articulation at stage 301, such as the user holding down one or more buttons corresponding to articulation operations (or a user pressing a button indicating that one or more articulations are to be performed until the user presses another or the same button to stop the articulation). While the articulation is ongoing, the airbed control system may perform pressure adjustments to maintain the original pressure level with the air chamber(s) of the air mattress at stage 302a, or may follow some other control logic with regard to what pressure adjustments should be made at stage 302b (such as targeting a first pressure level while the articulation is in a first range and then targeting a different pressure level once the articulation moves past the first range, or targeting a pressure corresponding to the current articulation level where the target pressure keeps changing while the articulation level is changing).

At stage 303, the direct drive user input for articulating the air mattress is stopped, resulting in the articulating motion being stopped at a current articulation. At stage 304, the pressure adjustment is correspondingly stopped once the original pressure for the air mattress chamber(s) is reached or target pressure corresponding to that articulation is reached. It will be appreciated that stage 304 occurs simultaneously with the presence of the direct drive input and may continue after the direct drive input ends at stage 303.

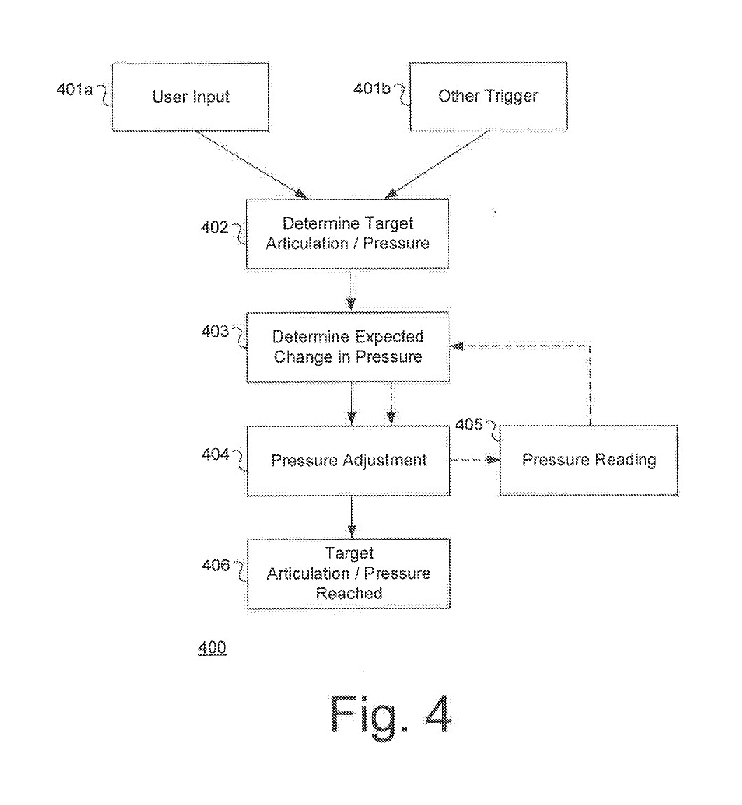

FIG. 4 is a flowchart 400 illustrating exemplary processes for pressure compensation by an airbed control system based on a target setting for articulation and pressure. The process shown in flowchart 400 may begin with a user input 401a, for example, corresponding to a user input on a user remote indicating the user desires a certain function (e.g., massage, sleep, reading), or certain memory setting (e.g., flat with a certain firmness, upright with a certain firmness, a zero gravity setting, etc.), or even a direct input of both an articulation and a pressure setting (e.g., the user simply specifies a desired articulation and a desired air pressure). It may also begin based on some other trigger 401b, for example, such as a programmed routine that causes the airbed to be articulated a certain way at a time of day or upon completion of an event such as completion of a massage, or upon detection of a certain condition such as detecting snoring or sleep apnea-related conditions (e.g., through an audio sensor or other types of sensors).

At stage 402, based on the user input 401a or the trigger 401b, the airbed control system determines what the target articulation and pressure settings are. At stage 403, the airbed control system determines what the expected change in pressure caused by the articulation will be, and performs pressure adjustment at stage 404 based on the expected change and the target pressure while the articulation is ongoing. It will be appreciated that the pressure adjustment at stage 404 may continue even after the articulation is complete, as the pressure adjustment may take longer than the corresponding articulation. Further, while the articulation and/or pressure adjustment is ongoing, further pressure readings may be taken at stage 405 (e.g., via dynamic pressure reading techniques), and together with the current state of the articulation, may be used to compute a new expected change in pressure (repeating stage 403) and update the pressure adjustment procedure at stage 404 based thereon (as indicated by dotted loop in FIG. 4). The process 400 concludes when both the target articulation and target pressure are achieved at stage 406 (it will be appreciated that it may take longer for the target pressure to be achieved than for the target articulation to be achieved).

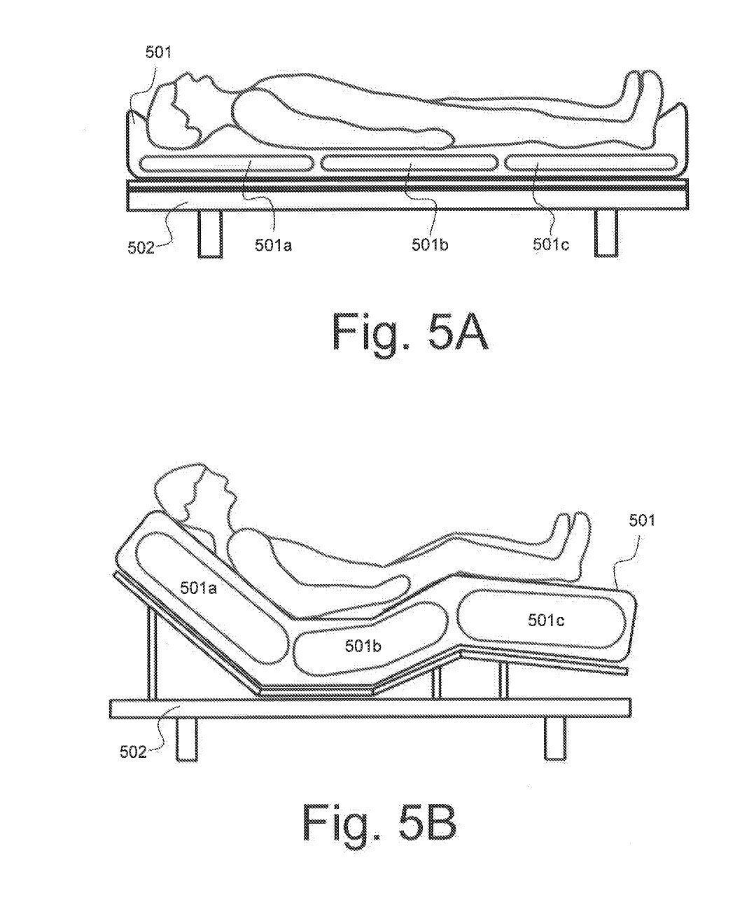

FIGS. 5A and 5B illustrate an exemplary six-zone air mattress 501 and an adjustable base 502 in two exemplary articulation configurations. Three exemplary air mattress chambers 501a, 501b, and 501c from one side of the air mattress 501 are illustrated in both these figures. In FIG. 5A, the adjustable base 502 is flat, such that a user may lie down flat on the air mattress 501. In FIG. 5B, the adjustable base is in a reclined setting, where the “Head” zone is elevated the highest, the “Foot” zone is moderately elevated, and the “Lumbar” zone is partially flat and partially slightly elevated.

There are multiple exemplary ways in which the airbed control system can be controlled to cause the airbed to assume the configurations shown in FIGS. 5A and 5B, or to go from one configuration to the other. For example, a user may hit a button or otherwise input a command on a user remote corresponding to a pre-programmed “flat” setting or a user-programmed flat setting where the airbed is flat, which may cause the adjustable base 502 to be adjusted to the flat setting shown in FIG. 5A (and at the same time the airbed control system adjusts the pressure within the air mattress chambers 501a, 501b and 501c to achieve target pressures for each of those chambers corresponding to the flat setting). Likewise, a user may hit a button or otherwise input a command on a user remote corresponding to a pre-programmed “recline” setting or a user-programmed setting where the airbed is reclined, which may cause the adjustable base 502 to be adjusted to the reclined setting shown in FIG. 5B (and at the same time the airbed control system adjusts the pressure within the air mattress chambers 501a, 501b and 501c to achieve target pressures for each of those chambers corresponding to the reclined setting).

The user may also provide direct drive user input, for example, simultaneous or sequential direct drive inputs corresponding to both the “Head” and “Foot” area on the adjustable base to achieve the settings shown in FIG. 5A or 5B (and at the same time the airbed control system adjusts the pressure within the air mattress chambers 501a, 501b and 501c to maintain original pressures within those chambers or to achieve target pressures corresponding to the degree of articulation).

In another example, a user laying on a flat mattress as shown in FIG. 5A may invoke a function via the user remote such as a massage function, and, in response to the invocation of the function, the airbed control system causes the airbed to be articulated to a non-flat setting such as the reclined setting shown in FIG. 5B (with appropriate adjustments to the pressure in the air mattress chambers to maintain the original pressure or to achieve a target pressure corresponding to the massage). The airbed then provides a massage while the airbed is in the non-flat setting, and then once the massage is over, it automatically causes the airbed to be articulated back to the flat setting shown in FIG. 5A (with appropriate adjustments to the pressure in the air mattress chambers to maintain the original pressure or to achieve a target pressure corresponding to the flat setting).

In yet another example, a user may give an input corresponding to a time of day such as pressing a “Morning” button or a “Morning” operation may automatically be triggered at a particular time of day to achieve a desired articulation and/or pressure level. For example, it may be desirable after the user has gotten out of the airbed to make sure the airbed is in the position shown in FIG. 5A and fully inflated to given a neat and squared off appearance.

In yet another example, a user may configure the airbed control system with a relatively sophisticated set of user preferences. For instance, the user may specify that certain pressure(s) be maintained across all elevation ranges according to a static relationship (same psi for all elevations) or variable relationship (e.g., lesser pressure at higher elevations). In one example, the user may configure the air chambers be “full” when the adjustable base is flat, and progress to be no more than a pre-determined minimum psi level (e.g., 0.35 psi) at a maximum articulation (e.g., when the head and/or foot zone are at maximum elevation), with interim articulations resulting in a scaled pressure level between the minimum (0.35 psi) and the maximum (psi at “full” level). In another example, the user may also specify a non-linear relationship between elevations and pressure.

In yet another example, various triggers may be utilized by the airbed control system to perform an articulation of the airbed (and correspondingly adjust the pressure based on the articulation). The triggers may include time-related triggers (such as changing elevation and/or pressure based on time of day), biometric-related triggers (such as changing elevation and/or pressure based on detecting changes with respect to snoring, heart rate, respiration, lack of movement, etc.), interventional triggers (such as changing elevation and/or pressure based on someone other than the user of the airbed, e.g., a nurse attending to a patient), function-related triggers (such as changing elevation and/or pressure based on invocation or completion of a massage function), or other triggers (e.g., based on temperature, lighting, ambient sound, music, etc.).

Exemplary implementations of the control logic used by the exemplary embodiments will be provided below to demonstrate examples of how the airbed control system models expected changes in pressure based on an ongoing or requested articulation. It will be appreciated that the principles of this control logic are universally applicable across a large variety of articulating base and air mattress combinations. Bases can have one, two, or more points of articulation and operate each side of the bed individually or in tandem. Likewise, the system of air mattress chambers can include six or more individually controlled zones and be segregated into sides or span the entire sleep surface.

In the interest of brevity, the exemplary implementations described herein will include a relatively complex model likely to be encountered in the consumer space with respect to a single side, two articulation inputs, and a three chamber mattress that has been divided into two zones, with a pumping configuration for altering pressure in a single zone at a time. It will be appreciated that the principles described in connection with these exemplary implementations may be extrapolated to perform similar adjustments in other implementations, such as providing identical adjustments to a second side in a linked articulation style base (e.g., a 6-zone configuration with 3 zones on each side, where the articulation simultaneously effects the 3 zones on each side in the same manner). Similarly, higher order medical grade controls that can simultaneously control pressure in multiple zones may utilize the described principles by running multiple single-zone control operations in parallel. Further, it will be appreciated that while 4-dimensional (and higher) geometry is difficult to represent via graphs, higher order polynomial response functions are not more difficult to solve than their 3rd and 4th order brethren using the techniques described herein (such higher order polynomial response functions just have more inputs and constants that are included).

As previously mentioned, three exemplary manners of adjusting the pressure within one or more air mattress chambers are provided as follows:

1) providing a pressure adjustment in response to a direct drive input from a user corresponding to an articulation change (with respect to one or more articulations) with the goal of maintaining the original pressure in the air mattress chamber(s);
2) providing a pressure adjustment in response to a direct drive input from a user corresponding to an articulation change (with respect to one or more articulations) with the goal of achieving a preferred pressure in the air mattress chamber(s) corresponding to a current articulation during the articulation change or following some other control law (such as maintaining pressure for a particular range of articulations); and
3) providing a stored pairing between a particular articulation and pressure level(s) within air mattress chamber(s), for example through a one-button recall by the user (e.g., in response to pressing a button corresponding to a function such as massage or a stored setting such as flat/full or upright reading) or through automatic recall (e.g., in response to detecting snoring/apnea-related conditions or to a certain time of day or other trigger).
It will be appreciated that (1), (2) and (3) may utilize similar control logic, as all of the control operations are targeting a desired pressure corresponding to an articulation setting, the difference being that in (1) and (2) the final desired articulation is not known ahead of time because the articulation is changing in real time based on the direct drive input.

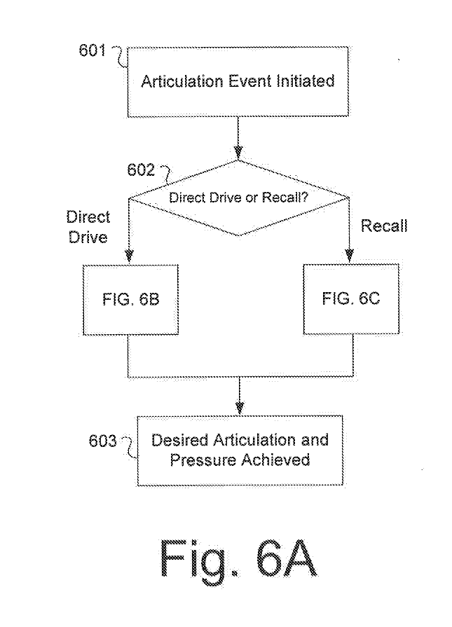

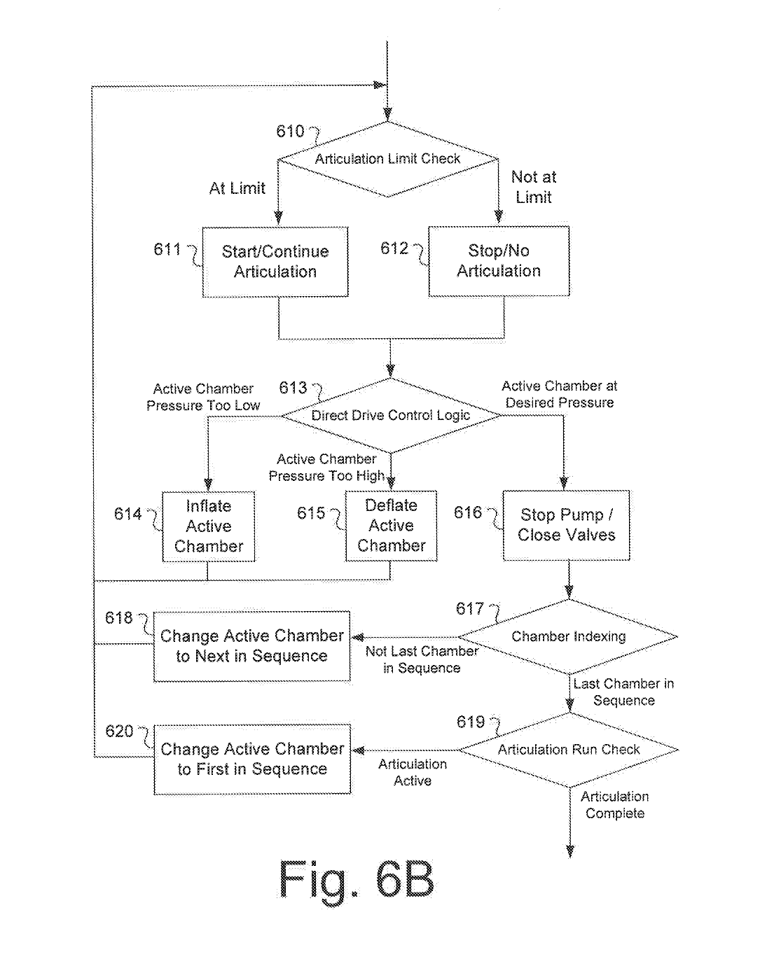

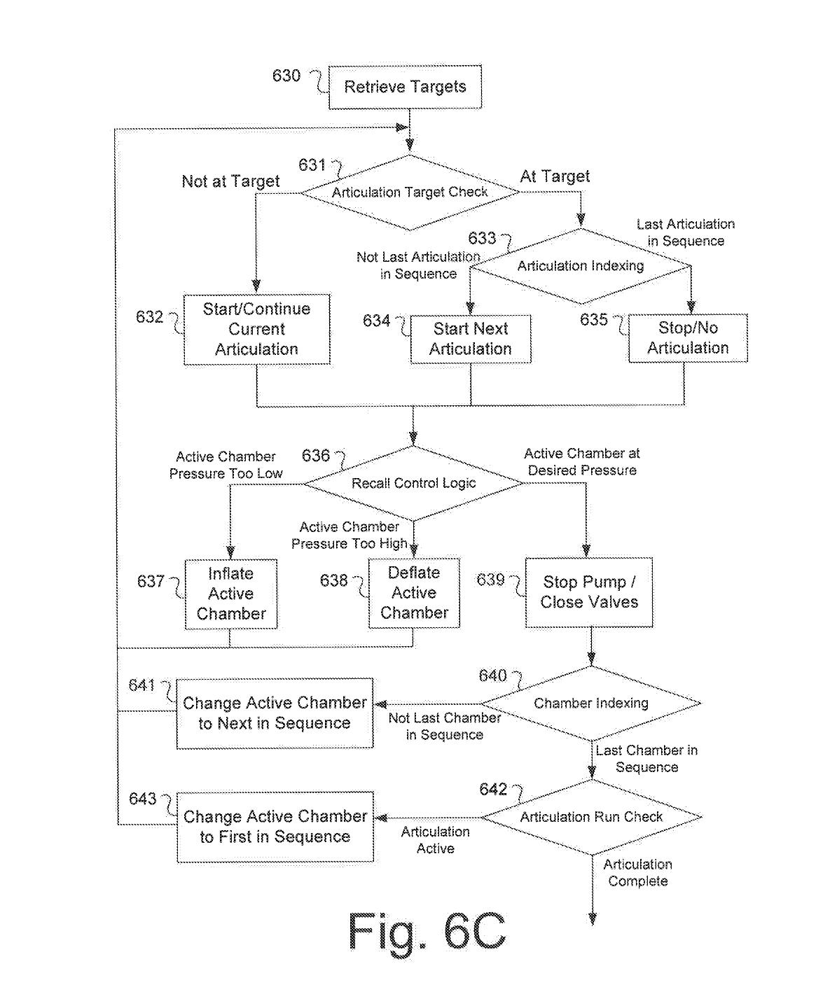

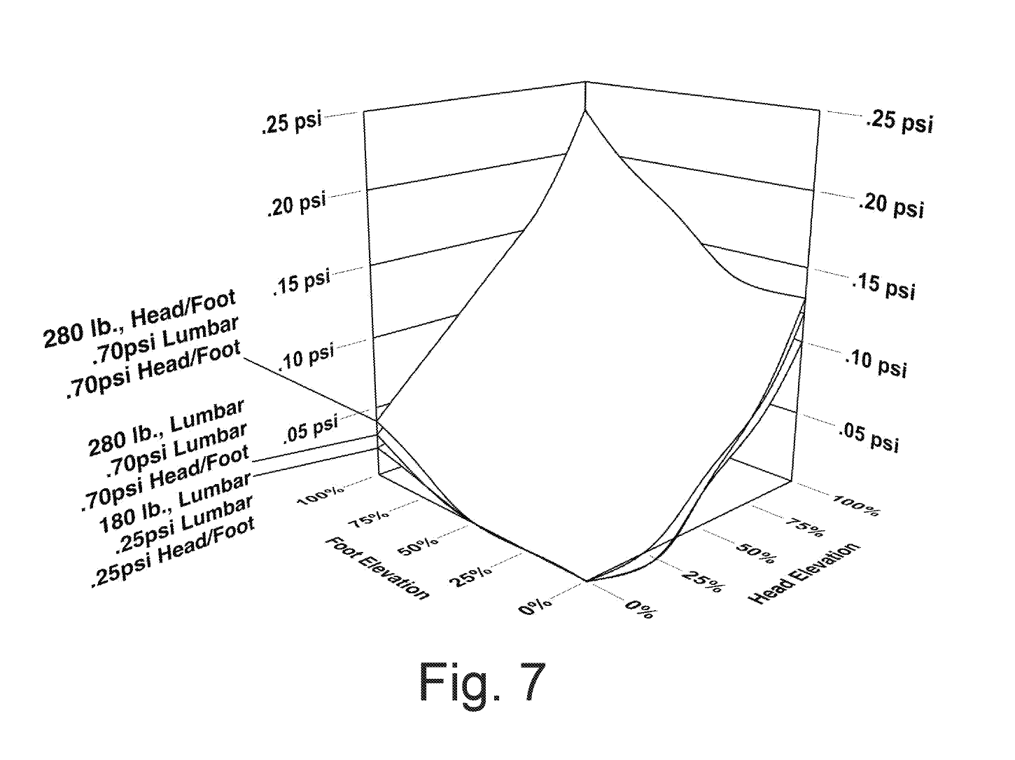

FIGS. 6A-6C are flowcharts illustrating an exemplary process flow for a multi-chamber (or multi-zone) system capable of direct drive control or recall-based control. FIG. 6A illustrates the overall process, which includes the initiation of an articulation event at stage 601. Based on whether the articulation event is a direct drive event or a recall event (stage 602), one of the exemplary processes shown in FIGS. 6B and 6C is performed. Upon completion, the desired articulation and pressure associated with the articulation event is achieved at stage 603. It will be appreciated that the steps shown in FIGS. 6A-6C are exemplary, and that the contents/order of the steps may be different in different exemplary embodiment of the invention. For example, although the exemplary process depicted in FIGS. 6A-6C and the corresponding description relate to a multi-zone system in which only one zone is operated on at a time, and in which only one actuation point is actuated at a time, it will be appreciated that the principles described herein may also be applied to systems where multiple zones are simultaneously operated on or when multiple actuation points are simultaneously actuated with appropriate modifications.

At stage 601, the process may be initiated by a direct drive input for adjusting the articulation of the airbed or a user input or trigger setting a target articulation and/or pressure level. Regardless of the way the process is initiated, the current (or “starting” or “original”) values will be recorded with respect to all articulation parameters and all chamber pressures. Consider a 2-zone example with 3 chambers (i.e., one zone corresponding to the “lumbar” region, and another zone corresponding to the combined “foot” and “head” regions) and 2 articulation points (i.e., one corresponding to a “head” area and one corresponding to a “foot” area—e.g., as depicted in FIG. 5B). The starting values include the following four parameters:
Base_Head_Elevation_{(Starting)}
Base_Foot_Elevation_{(Starting)}
Chamber_Lumbar_Pressure_{(Starting)}
Chamber_HeadFoot_Pressure_{(Starting)}

An exemplary process for achieving the desired articulation and pressure for a direct drive articulation event is shown in FIG. 6B. At stage 610 current articulation data (e.g., elevation data) is obtained and checked against the allowable limits of articulation. Based on whether the current articulation data is at the limit or not, the airbed control system determines whether articulation should be performed (e.g., by starting or continuing articulation (stage 611) or whether articulation should not be performed (e.g., by stopping articulation or continuing not to articulate (stage 612)).

Whether the articulation is ongoing or not, at stage 613 the airbed control system utilizes direct drive control logic to determine whether to inflate an “active” chamber (or zone) at stage 614, deflate the active chamber or zone at stage 615, or to stop the inflate/deflate operation and close the values for that chamber or zone at stage 616. To make this determination, current pressures are read for all chambers under active control (in some embodiments, current pressures may be checked for all chambers and not just the active chamber/zone).

For the present example, the current pressure may be:
Chamber_Lumbar_Pressure_{(Current)}

or
Chamber_HeadFoot_Pressure_{(Current)}
   depending on which zone is currently active. The current value for the Lumbar and HeadFoot pressure readings referenced above may correspond to the “static” value of the pressure in the chamber as determined via a dynamic pressure reading determined as described in U.S. patent application Ser. No. 14/571,834, or alternatively, via static pressure readings taken via a dedicated pressure transducer rigidly connected to a static pressure tap in the chamber.

It will be appreciated that when controlled via direct drive input, the airbed control system does not have information on the desired articulation values. However, the desired pressure values may still be determined according to certain previously user-defined or factory-default control laws—for example, a control law to maintain the starting pressure (such that the pressure adjustment accompanying the articulating action seeks to compensate for the pressure change caused by the articulation) or a control law through which a target pressure can be determined (e.g., for whatever articulation setting that the adjustable base moves to, a corresponding target pressure is determined).

In practice, while the user is driving the articulation, the desired articulation is set to match the current articulation, which is continually changing. For example:
Base_Head_Elevation_{(Desired)}=Base_Head_Elevation_{(Current)}
Base_Foot_Elevation_{(Desired)}=Base_Foot_Elevation_{(Current)}

In an instance where it is desired to maintain the starting pressure, the desired pressure for the air mattress chamber(s) is set to the original pressure prior beginning the articulation. For example:
Chamber_Lumbar_Pressure_{(Desired)}=Chamber_Lumbar_Pressure_{(Starting)}
Chamber_HeadFoot_Pressure_{(Desired)}=Chamber_HeadFoot_Pressure_{(Starting)}
   In an instance where other control laws are followed, the desired pressure for the air mattress chamber(s) may be set based on the current articulation (e.g., as a function of current articulation). For example:
If Base_Head_Elevation_{(Current)}<50% then Chamber_Lumbar_Pressure_{(Desired)}=0.70 psi
If Base_Head_Elevation_{(Current)}>50% then Chamber_Lumbar_Pressure_{(Desired)}=0.55 psi
If Base_Head_Elevation_{(Current)}<50% then Chamber_HeadFoot_Pressure_{(Desired)}=0.60 psi
If Base_Head_Elevation_{(Current)}>50% then Chamber_HeadFoot_Pressure_{(Desired)}=0.45 psi

Thus, while the airbed is articulating and the pressure adjustment is ongoing (or after the articulation has stopped and the pressure adjustment is still ongoing), the airbed control system will always have values for starting, current, and desired values for the articulation and pressure parameters. The decision at stage 613 to inflate (e.g., through pumping), deflate (e.g., through passive deflation or powered dumping), or do nothing (e.g., stopping the deflation/inflation operation and closing the valves to the chamber)—corresponding to stages 614-616, respectively—is made by the airbed control system based on inputting the current values for articulation and chamber pressure and the desired values for articulation and chamber pressure.

These parameters may be input into a set of rules or into a pressure response model for a particular chamber (or zone). The rules and/or the pressure response models for each chamber of the air mattress may be programmed into the software or firmware code for the airbed control system, with specific pressure response models being provided for different adjustable base/air mattress configurations.

While the pressure responses models are not necessary for the direct drive control logic at stage 613, a general form solution is provided as follows which will also be applicable to the recall control logic at stage 636 of FIG. 6C (which will be discussed below in further detail). It will thus be appreciated that the direct drive control logic at stage 613 may or may not utilize the pressure response models, which will be discussed as follows.

For exemplary embodiments utilizing pumps that can only adjust a single chamber or zone at a time, the pressure adjustment for each chamber may be done one at a time in a serial manner. An example is provided below with respect to performing a pressure adjustment for a HeadFoot zone of an air mattress. The inputs to the pressure response model for the HeadFoot zone are as follows:
Base_Head_Elevation_{(Current)}
Base_Foot_Elevation_{(Current)}
Chamber_Lumbar_Pressure_{(Current)}
Chamber_HeadFoot_Pressure_{(Current)}
Base_Head_Elevation_{(Desired)}
Base_Foot_Elevation_{(Desired)}
   Based upon these inputs, the pressure response model outputs an expected post-articulation pressure change for the HeadFoot zone:
Chamber_HeadFoot_Pressure_{(Anticipated}_{_}_{Delta)}

Utilizing the pressure response model and populating the anticipated delta pressure fields allows the use of the common control logic below for both direct control and paired recall operations.
If Chamber_HeadFoot_Pressure_{(Current)}−Chamber_HeadFoot_Pressure_{(Anticipated}_{_}_{Delta)}<=Chamber_HeadFoot_Pressure_{(Desired)}−0.01 psi then inflate
If Chamber_HeadFoot_Pressure_{(Current)}−Chamber_HeadFoot_Pressure_{(Anticipated}_{_}_{Delta)}>=Chamber_HeadFoot_Pressure_{(Desired)}+0.01 psi then activate dump
If Chamber_HeadFoot_Pressure_{(Current)}−Chamber_HeadFoot_Pressure_{(Anticipated}_{_}_{Delta)}−Chamber_HeadFoot_Pressure_{(Disired)}<=0.01 psi and >=−0.01 psi, then do nothing
   It will be appreciated that with respect to direct drive user input, the anticipated pressure change output of the pressure response model would be zero (because current articulation is set to equal desired articulation), and thus the pressure response model may not be needed for the decision of whether to inflate, deflate or do nothing in response to direct drive articulation. Accordingly, in certain exemplary implementations, the anticipated change in pressure term could be dropped from the control logic governing the direct drive control logic at stage 613.

If the direct drive control logic at stage 613 results in an inflation or deflation operation (stages 614 or 615), control is passed back to the articulation limit check at stage 610. The articulation limit check 610 and direct drive control logic 613 processes are ongoing until the active chamber is determined to be at the desired pressure, at which point the inflation or deflation operation is stopped and the valves corresponding to the active chamber are closed at stage 616.

At this point, because there are multiple chambers/zones, a chamber (or zone) indexing process is performed at stage 617. The indexing process dictates a predefined sequence in which the chambers will become the active and keeps track of which chamber in the sequence is currently active. For the present example, which includes both a head/foot zone and a lumbar zone, the predefined sequence may be:

1) Head/Foot

2) Lumbar

3) Head/Foot

4) Lumbar

It will be appreciated that the sequence includes repeated instances of setting each zone as active because in multi-zone systems, chamber pressure changes to one zone will typically change the pressure in adjacent ones. Additionally, ongoing articulation operations will continually impact all zones until they are completed.

Thus, at stage 617, upon reaching the desired pressure in the active chamber, if it is determined that the currently active chamber is not the last chamber in the sequence, the active chamber advances to the next chamber in the sequence at stage 618, and control is passed back to the articulation limit check at stage 610 (to repeat the articulation limiting operations and direct drive control operations as appropriate). On the other hand, if it is determined that the currently active chamber is the final chamber in the sequence at stage 617, control is passed to an articulation run check process at stage 619.

As previously mentioned, articulation will impact pressure in all chambers of a multi-zone airbed system, and pressure compensation may continue even after all articulations are complete (referred to as “truing up” the pressure). These final adjustments are typically relatively small and oftentimes looping back through the previous stages serves just to confirm that the system has arrived at its intended pressure target(s) in real time. The articulation run check process at stage 619 checks if all articulations are complete after the entire sequence of chambers in the chamber indexing process 617 have been determined to be at the desired pressure.

If the articulation run check process at stage 619 determines that articulation is still active, the active chamber for the chamber indexing process is reset to the first in sequence at stage 620, and control is passed back to the articulation limit check at stage 610. This ensures that the effect of the ongoing articulation on the pressure in the chamber(s) will continue to be adjusted for as discussed above with respect to all chambers in the sequence. On the other hand, if the articulation run check process determines that articulation is not still active (i.e., the direct drive input has been completed), all articulations and pressures have arrived at their intended values (stage 603 of FIG. 6A) and the adjustment process is complete.

An exemplary process for achieving the desired articulation and pressure for a recall-based articulation event is shown in FIG. 6C. At stage 630, the target articulation and pressure values are obtained based on the recall operation—for example, by populating the following variables from memory for use in subsequent operations:
Base_Head_Elevation_{(Desired)}
Base_Foot_Elevation_{(Desired)}
Chamber_Lumbar_Pressure_{(Desired)}
Chamber_HeadFoot_Pressure_{(Desired)}

At stage 631 current articulation data (e.g., current elevation data) corresponding to a current articulation is obtained and checked against the target value for the current articulation (it will be appreciated that the present example is directed to an exemplary implementation where there are multiple articulation points, such as foot elevation adjustment and head elevation adjustment, and where the articulation operations are performed in series). For example, the parameters corresponding to the two articulation points in this example may be:
Base_Head_Elevation_{(Current)}
Base_Foot_Elevation_{(Current)}

It will be appreciated that the manner of articulation may be based on the adjustable base's capabilities. For example, some adjustable bases are able to drive multiple articulations simultaneously, while some adjustable bases having multiple points of articulation are only able to drive one articulation at a time. Some adjustable bases do articulations both in series and in parallel (e.g., in series for elevating articulation, in parallel for decreasing articulation). Additionally, certain manufacturers have articulation sequencing requirements that should be followed by the control logic. For airbed control systems where the adjustable bases utilizes an articulation in series, the system may process a first articulation (e.g., chosen randomly or based on a manufacturer-preferred order) completely and then sequence through any remaining articulations, or alternatively employ any multiple incremental movements that are desired.

If the level of articulation for the current articulation is not at the target level of articulation, the articulation operation for the current articulation is continued at stage 632. If the level of articulation for the current articulation is at the target level of articulation, an articulation indexing operation is performed at stage 633 to determine whether additional articulations need to be performed. If the current articulation is not the last articulation to be performed in a sequence of articulations, the current articulation is stopped and a next articulation in the sequence is started at stage 634. If the current articulation is the last articulation to be performed in the sequence of articulations, the articulation operation is stopped at stage 635. As the loop back point in the logic structure, it will be appreciated that control decisions will be made using any or all of the current articulation values.

Whether the articulation is ongoing or not, at stage 636 the airbed control system utilizes recall control logic to determine whether to inflate an “active” chamber (or zone) at stage 637, deflate the active chamber or zone at stage 638, or to stop the inflate/deflate operation and close the values for that chamber or zone at stage 639. To make this determination, current pressures are read for all chambers under active control (or for all chambers). For the present example, the current pressure may be:
Chamber_Lumbar_Pressure_{(Current)}

or
Chamber_HeadFoot_Pressure_{(Current)}
   depending on which zone is currently active. The current value for the Lumbar and HeadFoot pressure readings referenced above may correspond to the “static” value of the pressure in the chamber as determined via a dynamic pressure reading determined as described in U.S. patent application Ser. No. 14/571,834, or alternatively, via static pressure readings taken via a dedicated pressure transducer rigidly connected to a static pressure tap in the chamber.

At stage 636, the airbed control system utilizes the current pressure readings, together with the desired targets previously obtained at stage 630 to determine whether to inflate (e.g., through pumping), deflate (e.g., through passive deflation or powered dumping), or do nothing (e.g., stopping the deflation/inflation operation and closing the valves to the chamber)—corresponding to stages 614-616, respectively. As discussed above in connection with FIG. 6B, this decision may be made based on an expected pressure change caused by the articulation operation, which is provided by specific pressure response models for particular chambers (or zones). For example, the recall control logic at stage 636 may follow the following rules:
If Chamber_HeadFoot_Pressure_{(Current)}−Chamber_HeadFoot_Pressure_{(Anticipated}_{_}_{Delta)}<=Chamber_HeadFoot_Pressure_{(Desired)}−0.01 psi then inflate
If Chamber_HeadFoot_Pressure_{(Current)}−Chamber_HeadFoot_Pressure_{(Anticipated}_{_}_{Delta)}>=Chamber_HeadFoot_Pressure_{(Desired)}+0.01 psi then activate dump
If Chamber_HeadFoot_Pressure_{(Current)}−Chamber_HeadFoot_Pressure_{(Anticipated}_{_}_{Delta)}−Chamber_HeadFoot_Pressure_{(Desired)}<=0.01 psi and >=−0.01 psi, then do nothing
   In other words, if the current pressure in the chamber minus the expected pressure change to be caused by articulation (relative to the current pressure and current articulation) is less than the desired pressure, the chamber is inflated (stage 637); if the current pressure in the chamber minus the expected pressure change to be caused by articulation (relative to the current pressure and current articulation) is greater than the desired pressure, the chamber is deflated (stage 638); and if the current pressure in the chamber minus the expected pressure change to be caused by articulation (relative to the current pressure and current articulation) is approximately equal to the desired pressure, inflation/deflation are not performed (stage 639) and the valves corresponding to the chamber or zone are closed.

If the recall control logic at stage 636 results in an inflation or deflation operation (stages 637 or 638), control is passed back to the articulation target check at stage 631. The articulation target check 631 and recall control logic 636 processes are ongoing until the active chamber is determined to be at the desired pressure, at which point the inflation or deflation operation is stopped and the valves corresponding to the active chamber are closed at stage 639.

At this point, because there are multiple chambers/zones, a chamber (or zone) indexing process is performed at stage 640, similar to the foregoing description regarding stage 617 of FIG. 6B. The indexing process dictates a predefined sequence in which the chambers will become the active and keeps track of which chamber in the sequence is currently active.

Thus, at stage 640, upon reaching the desired pressure in the active chamber, if it is determined that the currently active chamber is not the last chamber in the sequence, the active chamber advances to the next chamber in the sequence at stage 641, and control is passed back to the articulation target check at stage 631 (to repeat the articulation target checking operations and recall control operations as appropriate). On the other hand, if it is determined that the currently active chamber is the final chamber in the sequence at stage 640, control is passed to an articulation run check process at stage 642.

Similar to stage 619 of FIG. 6B, the articulation run check process at stage 642 checks if all articulations are complete after the entire sequence of chambers in the chamber indexing process 640 have been determined to be at the desired pressure. If the articulation run check process at stage 642 determines that articulation is still active, the active chamber for the chamber indexing process is reset to the first in sequence at stage 643, and control is passed back to the articulation limit check at stage 631. On the other hand, if the articulation run check process at stage 642 determines that articulation is not still active (i.e., the recall articulation has been completed), all articulations and pressures have arrived at their intended values (stage 603 of FIG. 6A) and the adjustment process is complete.

The pressure response models will be discussed in further detail as follows. Generally speaking, each model takes as input the current pressure and articulation values and the desired articulation values, and based thereon provides an output corresponding to the expected pressure change for a particular air mattress chamber or zone. Airbeds with multiple chambers or multiple zones will have a different pressure response model for each chamber or zone.

While the pressure response models are specific to zones/chambers of a combined adjustable base and air mattress configuration, the pressure response models are not meaningfully affected by the following:
Minor variations in mattress and base manufacturing (i.e., data collected from a single example of a specific mattress and base design combination is applicable across all similar designs subject to an exemplary imposed accuracy specification of ±0.01 psi).
Weight of the occupant (i.e., although there are slight variations in the pressure response between occupant masses of 120 and 300 lbs, these variations are in the range of ±0.02 psi—and are thus easily absorbed by the learning algorithm for determining dynamic pressure readings corresponding to “static” pressure. The pressure responses for two subjects with a 100 lb weight difference are well within the ±0.005 psi range.).
Starting pressure in the chamber for a single-chamber pressure response model (i.e., starting pressure in a chamber with a single zone or multiple zones at the same pressure does not affect results, which is consistent with the adiabatic and reversible nature of the process). The case of a multi-chamber or multi-zone system having different starting pressures is a bit more complex.
Chamber design, provided the chambers are at a uniform pressure (i.e., in the example depicted in FIGS. 5A and 5B having two points of articulation and three separate chambers inside the mattress, the head and foot zones may be pneumatically connected to create a combined Head/Foot zone with the Lumbar zone located between them, such that the head and foot chambers will have uniform pressure and may be treated like a single chamber).

FIG. 7 is a three-dimensional plot illustrating a data set corresponding to different weights and pressures which shows the uniform behavior of the system. While the pressure response illustrated in FIG. 7 is complex, it is consistently complex with regard to the variable inputs of body mass and starting pressure. Thus, as demonstrated by FIG. 7, single zone chambers and multi zone systems with uniform pressures in all zones respond uniformly and their responses can be modeled with a modest 4th order polynomial surface equation or lookup matrix.

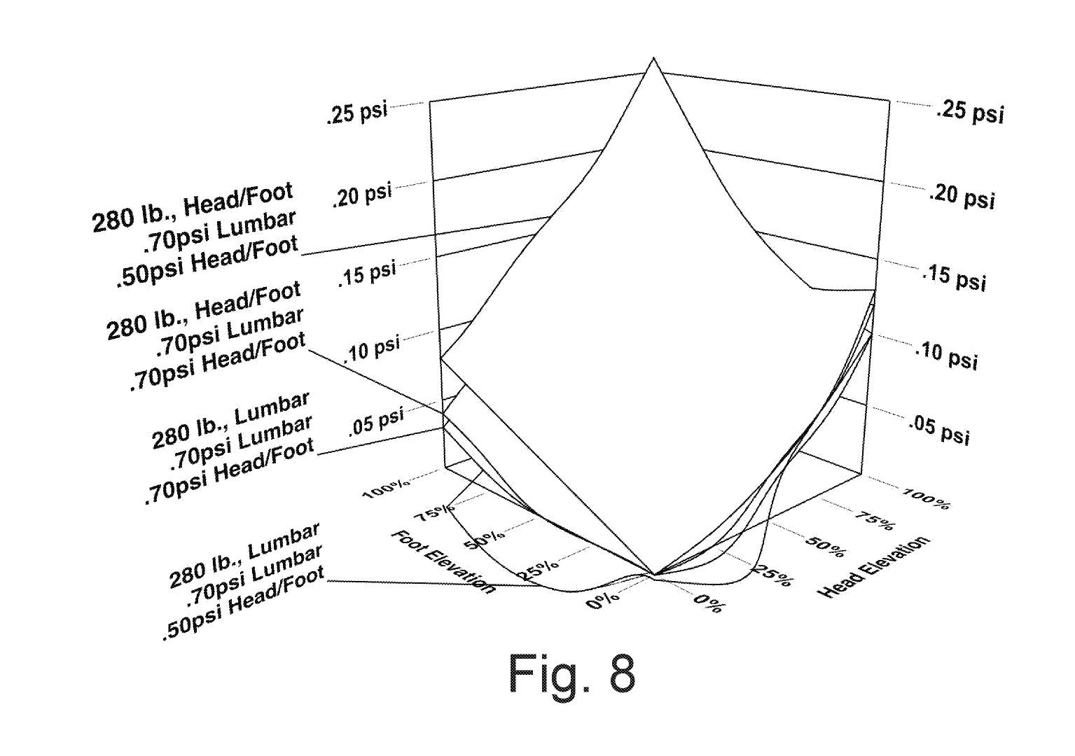

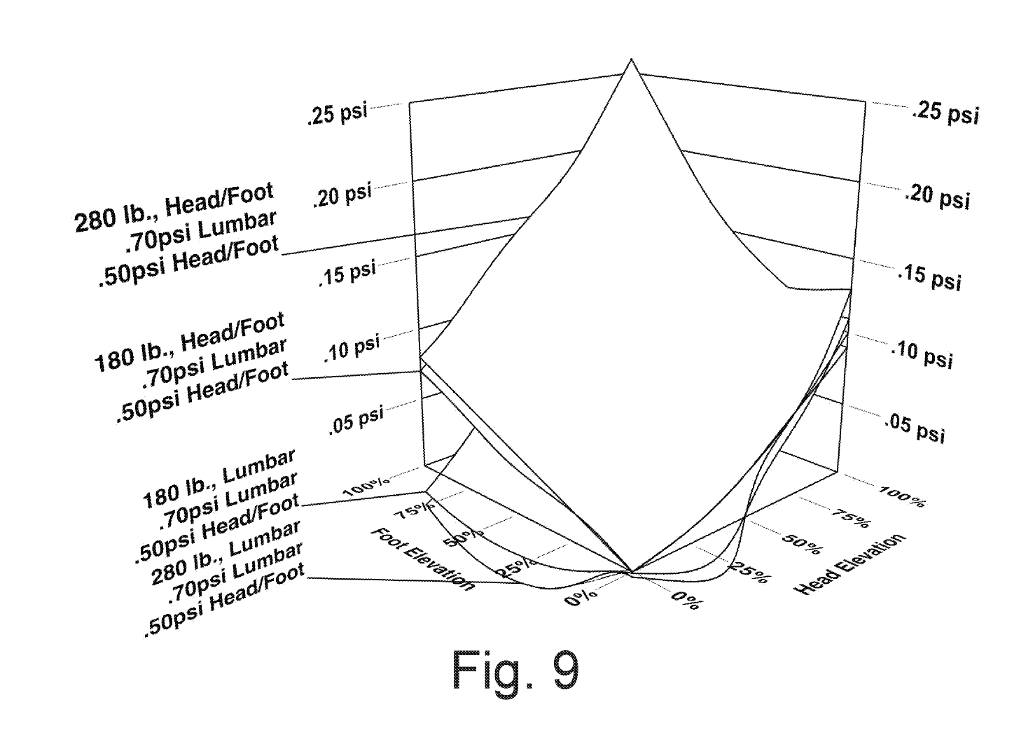

The pressure response model is also able to predict the pressure response behavior when subjected to non-uniform initial conditions (e.g., in a multi-zone system that is able to provide non-uniform support pressures across the sleep surface). FIG. 8 is a three-dimensional plot illustrating the effects of non-uniform initial pressure conditions in a multi-zone system. Although the system response in FIG. 8 is very different from the system response in FIG. 7 and clearly demonstrates how differential starting pressures in a multi-zone system drives the need for a chamber specific pressure response solution, it also illustrates the macro level similarities of even this combination of initial conditions. FIG. 9 is a three-dimensional plot that demonstrates the continued agnostic nature of the system to weight (i.e., illustrating different weights and different initial pressure combinations). The separation of the plots from the baseline is purely a function of the initial pressure delta between the two zones. While the number of zones and their physical location with respect to the articulation points of base is the ultimate arbitrary of the shape of the offset response surfaces, within a particular adjustable base and air mattress combination, the starting values of the pressures are the only parameter which impacts the ultimate pressure response of the system. However, it will be appreciated that for a multiple zone or chamber configuration, a unique pressure response model is provided for each zone or chamber, and all of the chambers' or zones' starting pressures are included in the call routines for the pressure response model.

Thus, in the foregoing example discussed above, the inputs into the pressure response models include:
Base_Head_Elevation_{(Current)}
Base_Foot_Elevation_{(Current)}
Chamber_Lumbar_Pressure_{(Current)}
Chamber_HeadFoot_Pressure_{(Current)}
Base_Head_Elevation_{(Desired)}
Base_Foot_Elevation_{(Desired)}
   A pressure response model for the Head/Foot zone then yields:
Chamber_HeadFoot_Pressure_{(Anticipated} _{_{Delta}}₎
   And a pressure response model for the Lumbar zone yields:
Chamber_Lumbar_Pressure_{(Anticipated}_{_}_{Delta)}
   It will be appreciated that the Chamber_HeadFoot_Pressure_{(Anticipated}_{_}_{Delta)} and Chamber_Lumbar_Pressure_{(Anticipated}_{_}_{Delta)} values may each be determined by evaluating the difference between two values (i.e., the difference between a pressure associated with a starting/current articulation point and a pressure associated with an ending point—for example, by comparing the difference between two points on any of the response surfaces shown in FIGS. 7-9).

The pressure response model for each chamber or zone may be configured by performing a polynomial surface fitting for the full spectrum of test data from a representative system. Although a 4th order polynomial surface fit with a weighting function per zone to account for multi-zone chambers is lengthy, it may be generated using modern data reduction software such as Matlab or Mathmatica based on providing a set of experimental data. The data reduction software then provides a formula, for example, having six inputs and 60 constants generated through the software (e.g., based on 15 constants provided for the base case and 15 for the particular zone, which is multiplied by two to account for both the current and desired elevations).

Obtaining the initial data set for generating the pressure response model may be performed by instrumenting the chambers in an air mattress with pressure transducers and collecting corresponding articulation data (typically in the form of an extension percentage for linear drive actuators). In the foregoing example, excellent results were achieved by obtaining data from trials in 0.05 psi increments with respect to starting pressure configurations and recording data at every 25% of articulation/elevation (e.g., by evaluating every possible initial starting pressure configuration from 0% foot elevation to 100% foot elevation and 0% head elevation to 100% head elevation, resulting in 25 data points per initial starting pressure configuration). For the exemplary 2-zone configuration with 2 points of articulation, this resulted in 8100 discrete pressure points (324 response surfaces with 25 data points each) which fully qualify the system (FIGS. 7-9 show subsets of these response surfaces with some added trials for different weights, but because it was demonstrated that weight does not have a significant effect on the expected pressure change, obtaining data for response surfaces corresponding to different weights is not needed). In an example with a single zone system with only a single point of articulation, a pressure response model may be generated with only 450 data points.

Given the rather modest data requirements to qualify the system, a potential alternative may be to employ an interpolating lookup table to avoid the relatively more computationally intensive 4th order polynomial surface fit with weighting (˜160 math operations per pass through the pressure response model). However, the lookup table is not scalable, and systems having more complex configurations (such as medical airbed systems with 3 points of articulation and 6 or more zones) will have exponentially larger lookup tables that results in the surface fit approach being more efficient. Other techniques involving matrix algebra may also be potential ways of generating the pressure response model at higher orders.

A general base form of an equation for a 4th order polynomial surface in an example is as follows:

P=p00+p10*x+p01*y+p20*x̂2+p11*x*y+p02*ŷ2+p30*x̂3+p21*x̂2*y+p12*x*ŷ2+p03*ŷ3+p40*x̂4+p31*x̂3*y+p22*x̂2*ŷ2+p13*x*ŷ3+p04*ŷ4,

where x corresponds to head elevation, y corresponds to foot elevation, and the fit coefficients are p00, p10, p01, p20, p11, p02, p30, p21, p12, p03, p40, p31, p22, p13, and p04. The full form equation for the example described herein has 4 repeats of this sequence, 2 using current elevation data and 2 using desired elevation data, 3 unique sets of fit coefficient, and a couple weighting terms that shift precedence between the two major terms as differential between the pressure in the chambers gets larger.

An exemplary advantage of certain embodiments discussed herein is that a user of an airbed is able to input a simple control, such as a direct drive articulation input or request a function or memory setting, and the airbed control system automatically performs intelligent pressure adjustments in response thereto to allow the airbed to achieve a desired comfort level for the user without requiring further inflate or deflate operations from the user in addition to an articulation operation. Another exemplary advantage is that integrated control of an adjustable based and a pump for an air mattress is available to the user, such that the user is able to simultaneously adjust both articulation and pressure, with the articulation and pressure adjustments running in parallel. This cuts the time for a combined adjustment of articulation and pressure, while also avoiding potential discomfort and/or overpressure conditions associated with serial adjustments.

This integrated control further provides for greater user customizability, as the user may establish stored correspondences between articulations and pressure levels within the air mattress chamber(s) in a memory of the airbed control system (such as a memory of a user remote or a pump control unit).

Another exemplary advantage of the techniques described herein is that, despite the fact that a requested articulation changes the amount of pressure in air mattress chamber(s), the airbed system can use the principles described herein to preemptively compensate for the expected change in pressure such that the desired pressure level post-articulation can be reached relatively quickly and efficiently. In other words, while the articulation is ongoing, the airbed control system takes into account the expected change due to the articulation to proactively perform the right amount of inflation or deflation to reach the desired post-articulation pressure level for the air mattress chamber(s) in a quick and efficient manner. The airbed control system is able to do this even when multiple articulations are simultaneously performed in addition to situations where articulations are sequentially performed.

Dynamic monitoring of pressure while the articulation and pressure adjustments are ongoing further allows for refinement of the pressure adjustment operation while it is ongoing. Dynamic monitoring also helps to address situations where the user is on the airbed while it is articulating and the articulation causes the user to adjust his or her position on the airbed while the pressure adjustment is still ongoing. While static monitoring of pressure may also be used (where the pressure is only measured while articulation and inflation/deflation are not ongoing), embodiments using static pressure measurement may not be able to achieve the target articulation and/or pressure as quickly as embodiments utilizing dynamic pressure measurement.

By using the real time dynamic pressure measurements in connection with goal-seeking control logic (so as to continue to check pressure during articulation until the articulation is complete), odd reflex features in the system response and divergent feedback loops can be avoided. For example, by performing two passes through all chambers in the chamber indexing sequence, resetting the chamber indexing sequence while articulation is ongoing, and the use of real-time pressures for the control logic such that the expected differential pressure is being updated in real time, the airbed control system is able to avoid potentially sub-optimal or inaccurate inflating/deflating operations when dealing with a trough or reflex in a pressure response surface corresponding to a pressure response model (e.g., as seen with the lumbar surfaces in FIG. 9).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An airbed system, comprising:
an air mattress comprising one or more air chambers;
an adjustable base comprising one or more articulation points; and
a pump connected to the one or more air chambers of the air mattress; and
a control system, wherein the control system is configured to:
control the adjustable base to perform an articulation operation; and
while the articulation operation is ongoing, control the pump to inflate or deflate the one or more air chambers of the air mattress based on the articulation operation being performed.

2. The airbed system according to claim 1, wherein the control system is further configured to: after the articulation operation is complete, continue to control the pump to inflate or deflate the one or more air chambers of the air mattress to one or more desired levels.

3. The airbed system according to claim 1, wherein controlling the adjustable base to perform the articulation operation is based on a direct drive user input, wherein the articulation operation is ongoing during the direct drive user input.

4. The airbed system according to claim 3, wherein the control system controlling the pump to inflate or deflate while the articulation operation is ongoing causes the one or more air chambers to be inflated or deflated towards an original pressure level within the one or more air chambers prior to the articulation operation.

5. The airbed system according to claim 3, wherein the control system controlling the pump to inflate or deflate while the articulation operation is ongoing causes the one or more air chambers to be inflated or deflated towards a target pressure level corresponding to a current articulation of the adjustable base.

6. The airbed system according to claim 1, wherein controlling the adjustable base to perform the articulation operation is based on a recall operation; and
wherein the airbed control system is configured to, based on the recall operation, obtain target articulation and pressure levels.

7. The airbed system according to claim 6, wherein the recall operation is based on a user input corresponding to a request for a stored setting or an airbed function.

8. The airbed system according to claim 6, wherein the recall operation is triggered by a determination by the control system that one or more conditions are met.

9. The airbed system according to claim 6, wherein the control system controlling the pump to inflate or deflate while the articulation operation is ongoing includes a determination of an expected change in pressure to be caused by the articulation operation relative to a current pressure level in the one or more air chambers.

10. The airbed system according to claim 9, wherein the expected change in pressure to be caused by the articulation operation relative to the current pressure level in the one or more air chambers is based on one or more pressure response models, wherein each pressure response model corresponds to an air chamber or a zone of the air mattress.

11. The airbed system according to claim 10, wherein inputs to the pressure response model include one or more current pressure levels, one or more current articulation levels, one or more target pressure levels, and one or more target articulation levels.

12. The airbed system according to claim 1, wherein the air mattress comprises multiple air chambers; and
wherein control system is further configured to perform a chamber indexing operation to control the pump to inflate or deflate the multiple air chambers according to a predetermined sequence.

13. The airbed system according to claim 1, wherein the adjustable base comprises multiple articulation points; and
wherein control system is further configured to perform an articulation indexing operation to control the adjustable base to articulate the multiple articulation points according to a predetermined sequence.

14. The airbed system according to claim 1, wherein the control system comprises a first controller corresponding to the adjustable base and a second controller corresponding to the pump.

15. A method for inflating or deflating in an airbed system to compensate for pressure changes caused by articulation, the method comprising:
performing, by an adjustable base of the airbed system, an articulation operation affecting a configuration of an air mattress of the airbed system; and
while the articulation operation is ongoing, inflating or deflating, by a pump of the airbed system, one or more air chambers of the air mattress based on the articulation operation being performed.

16. The method according to claim 15, further comprising:
receiving a direct driver use input corresponding to the articulation operation, wherein the articulation operation is performed while the direct drive user input is ongoing.

17. The method according to claim 15, further comprising:
obtaining, by a control system of the airbed system, a target articulation for the articulation operation and one or more target pressures corresponding to the one or more air chambers for the inflating or deflating.

18. A non-transitory computer-readable medium having processor-executable instructions stored thereon for inflating or deflating in an airbed system to compensate for pressure changes caused by articulation, the processor-executable instructions, when executed, facilitating performance of the following:
performing, by an adjustable base of the airbed system, an articulation operation affecting a configuration of an air mattress of the airbed system; and
while the articulation operation is ongoing, inflating or deflating, by a pump of the airbed system, one or more air chambers of the air mattress based on the articulation operation being performed.

19. The non-transitory computer-readable medium according to claim 18, wherein the processor-executable instructions, when executed, further facilitate:
receiving a direct driver use input corresponding to the articulation operation, wherein the articulation operation is performed while the direct drive user input is ongoing.

20. The non-transitory computer-readable medium according to claim 18, wherein the processor-executable instructions, when executed, further facilitate:
obtaining, by a control system of the airbed system, a target articulation for the articulation operation and one or more target pressures corresponding to the one or more air chambers for the inflating or deflating.
